(19) United States
(12) Patent Application Publication
(10) Pub. No.: US 2025/0214093 A1
(43) Pub. Date: Jul. 3, 2025

(54) MULTIFUNCTIONAL SPRAY HEAD ASSEMBLY

(71) Applicant: Kohler Co., Kohler, WI (US)

(72) Inventor: Jacob R. Frye, Sheboygan Falls, WI (US)

(21) Appl. No.: 18/977,642

(22) Filed: Dec. 11, 2024

Related U.S. Application Data
(60) Provisional application No. 63/615,993, filed on Dec. 29, 2023.

(51) Int. Cl. B05B 1/18; B05B 1/16

(52) U.S. Cl. CPC B05B 1/18; B05B 1/16

(57) ABSTRACT

A multifunctional spray head assembly and methods of operating the same. The spray head assembly includes a body, a switch, and a spray diverter assembly. The body defines a plurality of channels, including an inlet channel and at least three outlet channels. The switch is configured to be coupled with the spray diverter assembly such that linear movement of the switch translate to rotational movement of a shutter of the spray diverter assembly. The shutter diverts water into one of the outlet channels, which results in the spray head assembly dispensing water out of one of several discrete outlets.

### CROSS-REFERENCE TO RELATED APPLICATION

The present disclosure claims the benefit of U.S. Provisional Application No. 63/615,993, filed Dec. 29, 2023, which is hereby fully incorporated by reference in its entirety.

### TECHNICAL FIELD

Examples relate generally to systems comprising multifunctional spray head assemblies, and more specifically to multifunctional spray head assemblies comprising a water diverter configured to dispense fluids in multiple spray patterns.

### BACKGROUND

The present disclosure relates generally to the field of spray head assemblies through which fluids are dispensed. Traditional spray head assemblies define a singular internal channel through which fluid can pass. Because there is only a singular internal pathway, the fluid can only be dispensed through a singular outlet with a singular spray pattern. For example, basic spray head assemblies dispense fluid in a solid stream. There was a need in the field for a system configured to dispense fluids through different functional outlets of the same assembly.

Some conventional spray head assemblies attempted to address this issue with the introduction of a valve or diverter to the spray head assembly. In such systems, a user may actuate an internal valve to change the spray pattern by manipulating a button on the exterior of the spray head assembly. Such systems are limited, however, by the number of fluid pathways within the system. Other systems, such as bathroom shower heads, may use a turbine shutter to divert fluids into different outlets. Users manipulate the turbine shutter to change the spray pattern by pulling a tab on the outside of the faucet head, which rotates the turbine shutter inside the spray head. However, manipulation of the tab can be cumbersome or unwieldy for users because of the construction of the spray head.

There is a need in the field for a spray head assembly comprising a spray head diverter configured to dispense fluids in more than two discrete spray patterns. There is further need for a spray diverter that can be manipulated by the user through a more fluid mechanism.

### SUMMARY

An example according to the disclosure relates to a spray head assembly, including a body, a toggle switch or button, and a spray diverter. The spray diverter is housed in an interior of the body. The switch is functionally connected to the spray diverter, such that a user's manipulation of the switch causes the spray diverter to switch or toggle between spray modes. The switch is configured to be manipulated by the user into at least three positions, which correspond to at least three spray patterns at an outlet of the spray head assembly. When the switch is in a first position, the spray head assembly can dispense fluids in a first spray pattern. When the switch is in a second position, the spray head assembly can dispense fluids in a second spray pattern. When the switch is in a third position, the spray head assembly can dispense fluids in a third spray pattern.

The body of the spray head assembly comprises an inlet, an internal channel, a spray diverter, and an outlet housing. The inlet, internal channel, spray diverter, and outlet housing are in fluid connection such that when fluid enters the spray head assembly through the inlet, the fluid can pass through the assembly and exit the assembly through an outlet of the outlet housing.

In an example, the spray diverter comprises a shaft housing, a shaft, a shutter, and a channel divider. The shaft housing is coupled to the switch of the spray head assembly. The shaft housing defines a channel, which is configured to receive a first end the shaft. The shaft housing is configured such that when the switch moves the shaft housing linearly, the shaft rotates in either the clockwise or counterclockwise direction, depending in which linear direction the shaft housing moves. For example, when the switch is manipulated such that the shaft housing shifts towards the outlet of the faucet head assembly, the shaft consequently rotates in a counterclockwise direction. If the shaft housing is shifted in the opposite direction, the shaft rotates in the clockwise direction.

The shaft is configured such that a second end of the shaft (the end not coupled to the shaft housing) is coupled to the shutter and the channel divider. The shaft is coupled to the shutter and the channel divider such that rotation of the shaft results in rotation of the shutter relative to the channel divider. The shutter comprises a disk with openings, wherein the openings are arranged such that the openings can divert fluids to a series of outlet channels within the outlet housing.

The outlet housing comprises at least three outlet channels. The outlet channels divert the flow of fluid through the spray head assembly to a corresponding outlet. When the shutter is rotated, via manipulation of the switch, the openings of the shutter rotate from fluidly connecting the inlet channel with one outlet channel to a different outlet channel. This changes which outlet the spray head assembly dispenses water from.

The outlets may be configured in a variety of ways, to achieve the desired spray pattern. This may be a serious of smaller nozzles grouped together, or a singular nozzle with a particular spout shape, for example. The result is a spray head assembly that is configured to dispense water in a variety of spray patterns. In an example according to the disclosure, a method of diverting a flow of liquid to one of a plurality of outlets to modify a spray mode of a spray head assembly includes providing a spray head assembly having a spray diverter configured to modify a spray mode of a spray head assembly, causing a user input to be received by the spray diverter indicative of a desired spraying operation upon an actuating mechanism of the spray head assembly, causing a shaft housing coupled to the actuating mechanism to selectively move to a different operating position on a shaft based on the received user input, and based on the movement of the shaft housing, causing the shaft coupled to the shaft housing to rotate to align one or more openings of a shutter with one or more sections of a channel divider fluidically coupled to at least one nozzle to permit fluid passage through the at least one nozzle of the desired spraying operation. The shaft housing can be selectively moveable between at least three different operating positions on the shaft. In an example, selectively moving the shaft housing and rotating the shaft occur simultaneously. In an example, the shutter can include a connector extending perpendicularly from the shutter configured to couple to a distal end of the shaft.

The foregoing is a summary and thus by necessity contains simplifications, generalizations, and omissions of detail. Consequently, those skilled in the art will appreciate that the summary is illustrative only and is not intended to be in anyway limiting. Other aspects, features, and advantages of the device described herein, as defined by the claims, will become apparent in the detailed description set forth herein and taken in conjunction with the accompanying drawings.

### BRIEF DESCRIPTION OF THE DRAWINGS

FIG. 1 is a perspective view of a spray head assembly, having a switch configured to change the spray mode, according to an example.

FIG. 2A-2C are perspective views of a spray head assembly, having a switch movable into at least three positions.

FIG. 3 is a perspective view of a spray diverter assembly of the spray head assembly, according to an example.

FIG. 4 is an exploded view of a spray diverter assembly, according to an example.

FIG. 5 is an exploded view of a shaft assembly, having a shaft and a shaft housing, according to an example.

FIG. 6 is a side view of a shutter, according to an example.

FIG. 7 is a side view of a channel divider assembly, having a shutter and a channel divider, according to an example.

FIG. 8A-8C is a perspective view of a spray diverter assembly, having according to an example.

FIG. 9 is a cross-sectional side view of the interior of the spray head assembly, according to an example.

FIG. 10A-10C are cross-sectional side views of the interior of the spray head assembly, having three discrete channels through which fluid can pass, according to an example.

While various examples are amenable to various modifications and alternative forms, specifics thereof, have been shown by way of example in the drawings and will be described in detail. It should be understood, however, that the intention is not to limit the claimed disclosures to the particular examples described. On the contrary, the intention is to cover all modifications, equivalents, and alternatives falling within the spirit and scope of the subject matter as defined by the claims.

### DETAILED DESCRIPTION

Referring generally to FIGURES, disclosed herein are spray head assemblies configured to dispense fluids in at least three discrete spray patterns. The spray head assemblies may be configured for use with kitchen faucets or any other suitable application. The spray head assembly is configured to translate the linear movement of a switch into rotational movement of an interior shutter to change the spray pattern of fluid at an outlet of the spray head assembly. An interior shutter can divert fluid flowing through the spray head assembly into discrete channels, which end in discrete outlets having different spray patterns.

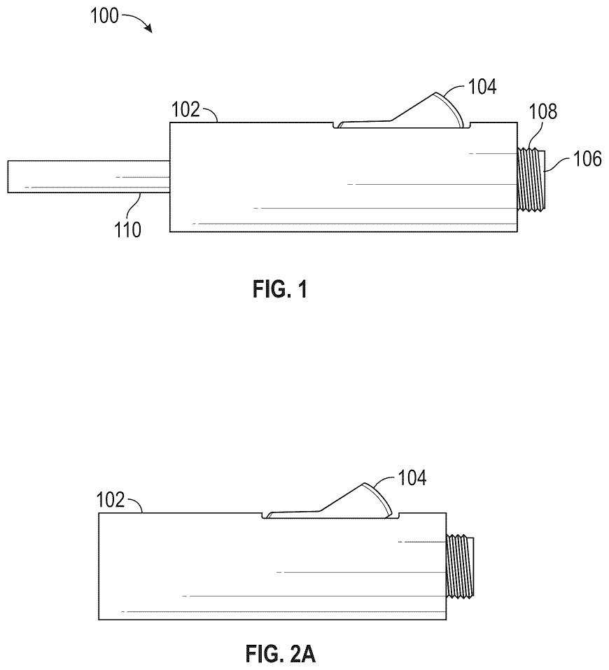

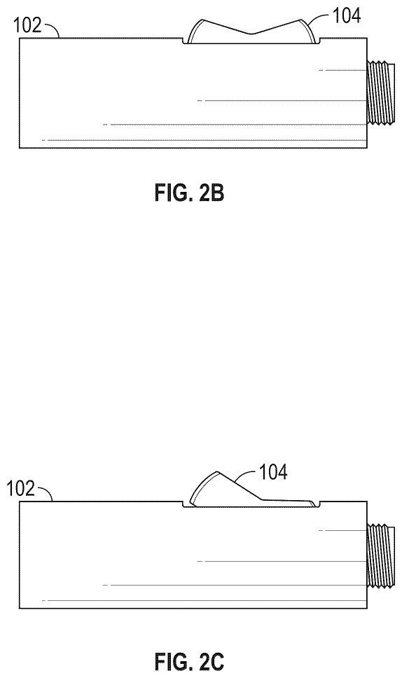

FIG. 1 depicts a non-limiting example of a spray head assembly 100 comprising a body 102 which includes structure defining an aperture through which a toggle switch or button 104 extends, and a spray diverter assembly 200 (FIG. 2) which is housed within body 102, and which will be described in more detail infra. The body 102 terminates at a first end including a fluid inlet 106, a threaded connection 108, while a second end terminates as an outlet housing 110. The inlet 106 and outlet housing 110 can be in fluid connection, such that fluids entering the spray head assembly 100 through the inlet 106 exit the spray head assembly 100 through the outlet housing 110.

The body 102 can be any suitable shape and length for the desired application. For example, the body 102 is generally cylindrical. In alternative examples, the body 102 may have a cross section that is generally rectangular, hexagonal, octagonal, or any other suitable polygon. The body 102 may be longer or shorter. It may be desirable in some applications to match the cross section of the spray head assembly 100 to that of a faucet system (not shown) if the spray head assembly 100 is intended to be coupled to the faucet system. The body 102 may be constructed of suitable rigid materials, including, but not limited to, metals, alloys, thermoplastics, other engineered materials, or any combination thereof. The material may match the faucet system (not shown) the spray head assembly 100 will be coupled to.

The threaded connection 108 may have male or female threads. The threaded connection 108 is configured such that it can be coupled in an airtight connection with a faucet system. In such examples, the faucet system can have complementary threading, meaning if the threaded connection 108 has male threads, the faucet system has female threads. The threaded connection 108 may also comprise another suitable connection type, such as, for example, welding or push-to-fit connection.

Referring to FIG. 2A-2C, the switch 104 is movable into at least three positions. A first position of the switch 104, shown in FIG. 2A, defines a first spray pattern from the outlet housing 110. A second position of the switch 104, shown in FIG. 2B, defines a second spray pattern from the outlet housing 110. A third position of the switch 104, shown in FIG. 2C, defines a third spray pattern from the outlet housing 110. The switch 104 can be configured to move into the positions by continuous actuation or snapping into discrete positions, depending on the configuration of the example.

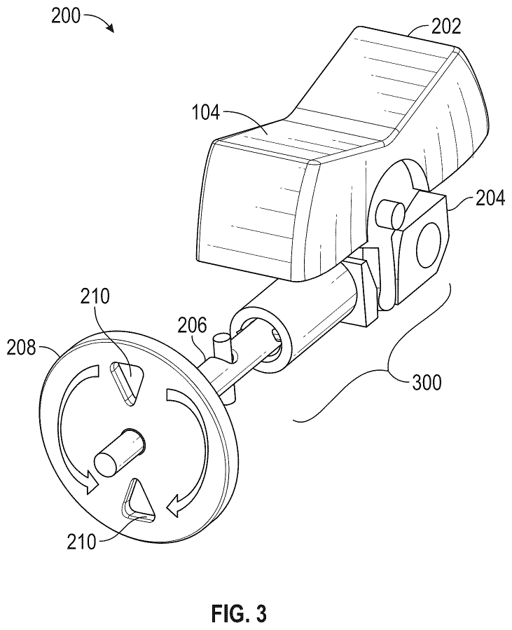

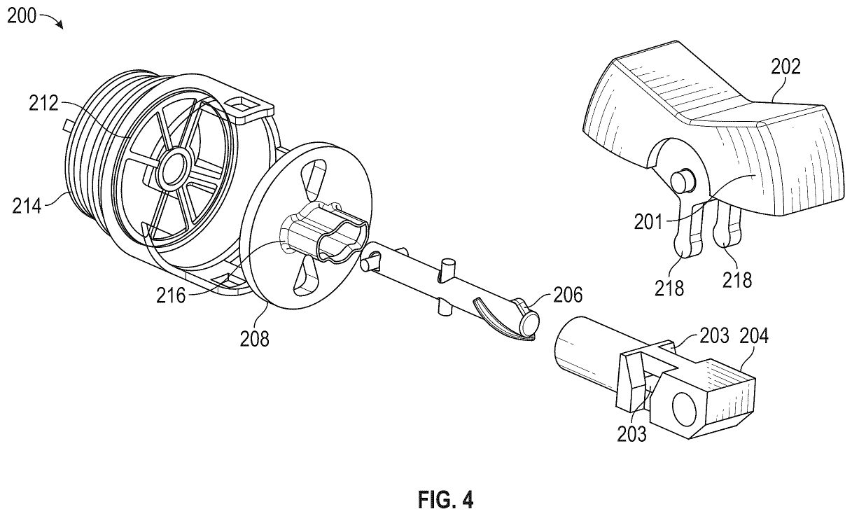

A spray diverter assembly 200 is configured to convert the linear movement of the switch 104 (as described supra) into the rotational movement of a shutter 208. Referring to FIG. 3, the switch 104 can comprise a switch body 202 coupled to a shaft assembly 300 including a shaft housing 204 coupled to a shaft 206. The shutter 208 is coupled to a distal end of shaft 206 opposite the shaft housing 204. The shutter 208 can be generally circular in cross section, or any other suitable shape to match the cross-sectional shape of the faucet (not picture) that the spray head assembly is coupled to. The shutter 208 includes one or more openings 210 for allowing fluid flow therethrough. Referring to FIG. 4, the openings 210 correspond to the discrete sections of a channel divider 212. The channel divider 212 and the shutter 208 can fit within a fluid outlet housing 214. The shutter 208 further comprises a connector 216. The connector 216 extends from the shutter 208 at a generally perpendicular angle. The shaft 206 is configured to be inserted into the connector 216, such that when the shaft 206 rotates, the shutter 208 rotates.

The switch body 202 comprises a main body portion 201 and a set of tabs 218, that extend from and below the main body portion 201, resembling a saddle. The set of tabs 218 are configured to be coupled with recesses 203 formed in the shaft housing 204 and leverage the shaft housing 204 into linear movement when the switch body 202 is manipulated by a user. The switch body 202 body further comprises angled portions that meet at the center of the switch body 202, which resembles a saddle. The angled portions are configured to be ergonomic points for a user to manipulate the switch body 202.

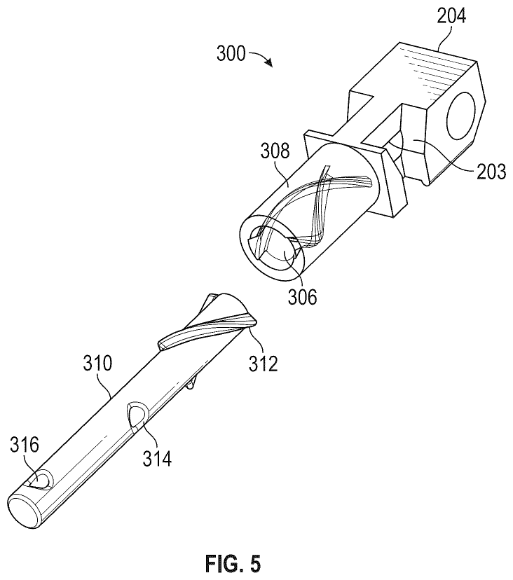

Referring now to FIG. 5, as discussed infra the shaft assembly 300 can comprise the shaft housing 204 and a shaft 206. The shaft 206 is configured to be inserted into an internal channel 306 of the shaft housing 204. The internal channel 306 further comprises a series of grooves 308 that correspond to a series of fins or threads 312 on an outer surface of the shaft 206. The groves 308 circumvent the internal channel 306. Similarly, the fins 312 extend along the exterior surface of the shaft 206 such that each fin extends along a portion of the length of the shaft 206 and partially circumferentially. The shaft 206 further includes openings 314, 316 for receiving pins 317 (FIG. 3) therethrough. In use, as the shaft housing 204 is moved linearly (by the switch (not shown), as described supra) along shaft 310, the fins 312 move along the grooves 308. Because the fins 312 extend about the circumference of the exterior of the shaft 206, this movement causes the shaft 206 to rotate either clockwise or counterclockwise, depending on which direction the shaft housing 204 is moving.

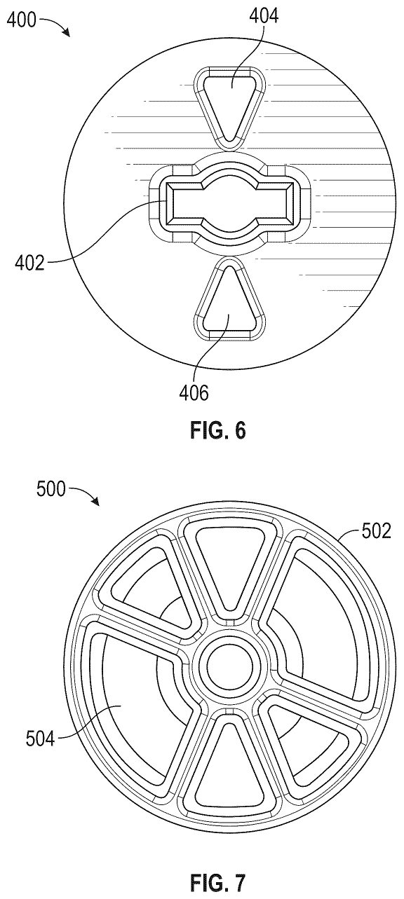

Referring to FIG. 6, an example of a shutter 400 can comprise a first opening 404, a second 406, and a connector 402. The connector 402 is generally situated between the first void 404 and the second void 406 at the center of the shutter. The connector 402 extends perpendicularly from the shutter, such that the shaft of the shaft assembly (not shown) can be coupled to the shutter 400 via the connector 402. The walls of the connector 402 may be tapered as it extends from the surface of the shutter 400 to secure the shaft of the shaft assembly (not shown) to the shutter 400. In other examples, the connector 402 may comprise further elements configured to secure the shaft of the shaft assembly to the shutter 400.

As discussed supra, the spray head assembly 100 is configured to divert fluids to different outlets via a channel diverter assembly 500, depicted in FIG. 7. The channel diverter assembly comprises a channel divider 502 with structure defining a plurality of openings 504. Pairs of openings 504 of the channel diverter assembly 500 define the inlet to corresponding outlet channels (not shown) or fluid path in a fluid discharge member. The openings of the shutter 504 are configured to correspond at least partly to the shape of the sections of the channel divider 502.

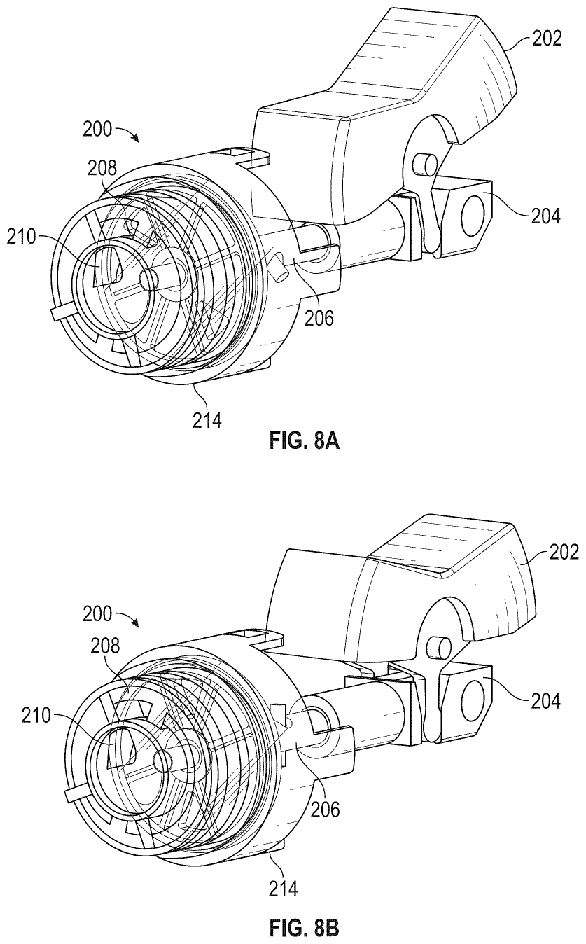

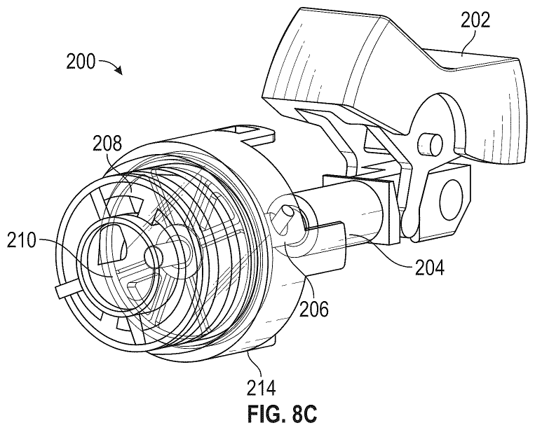

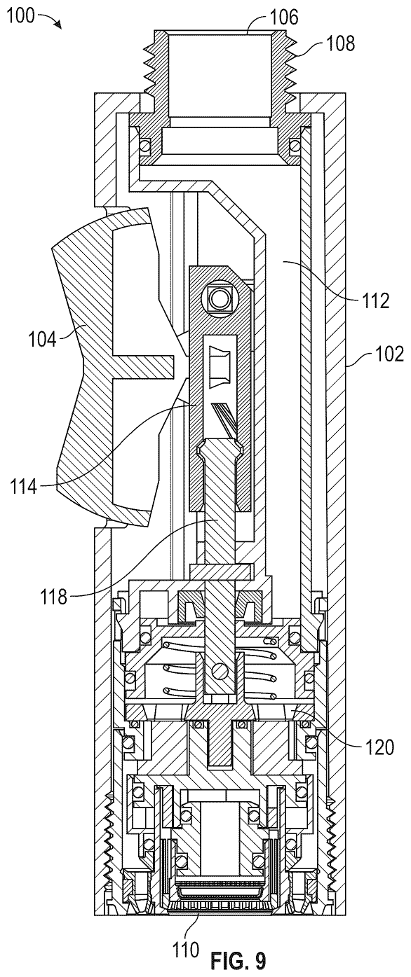

Now referring to FIG. 8A, when assembled and in use, the spray diverter assembly 200 comprises the switch body 202 coupled to the shaft housing 204 such that when a user moves the switch body 202 into a first position, the shutter 208 rotates into a first position, aligning with a first section of the channel divider 210. As the switch body 202 is moved, the shaft housing 204 shifts linearly, which in turn results in the rotation of the shaft 206. Because the shaft 206 is coupled to the shutter 208, this results in the rotation of the shutter 208. When a user moves the switch body 202 into a second position, depicted in FIG. 8B, the shutter 208 rotates into a second position, aligning the voids of the shutter 208 with a second section of the channel divider 210. When a user moves the switch body 202 into a third position, depicted in FIG. 8C, the shutter 208 rotates into a third position, aligning the voids of the shutter with a third section of the channel divider 210.

The body 102 further comprises a plurality of internal elements. Referring to FIG. 9, the body 102 defines an internal cavity, having an inlet channel 112 in fluid connection with the inlet 106 and the outlet housing 110. A shutter 120 is situated within the internal cavity between the inlet 106 and the outlet housing 110. The shutter 120 diverts fluid from the inlet 106 to one of at least three outlet channels.

A spray pattern is formed by the configuration of the outlet housing 110. In some examples, the outlet housing 110 comprises nozzles (not shown) or groupings of nozzles with spouts of varied sizes and shapes to achieve the desired spray pattern. For example, to achieve a spray pattern in a fan shape, a singular nozzle can have a long narrow opening. As another example, to achieve a spray pattern in a rainfall shape, a grouping of nozzles can have small, circular openings.

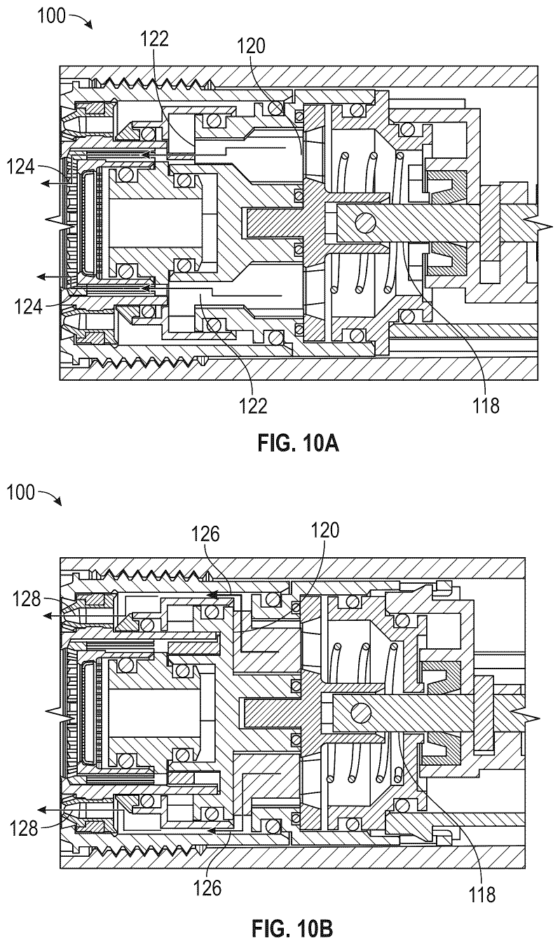

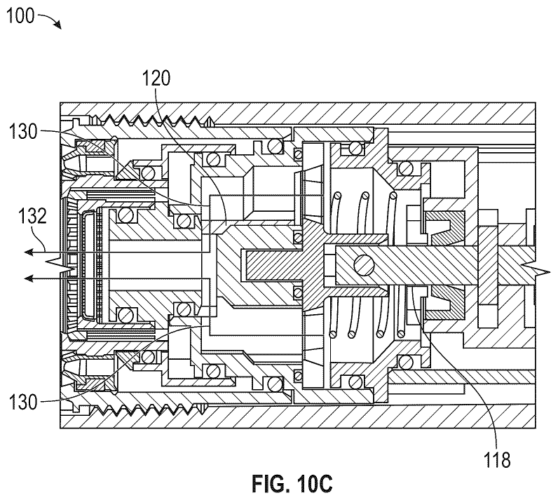

The shutter 120 is configured to divert water to different outlet channels within the body 102. Referring to FIG. 10A, a first outlet channel 122 is fluidly connected to a first nozzle arrangement 124. The shutter 120 can direct fluids in the spray head assembly 100 from the inlet channel 112 to the first outlet channel 122. To direct fluids to a particular channel, the voids (not shown) of the shutter 120 should align with the first outlet channel 122. Referring to FIG. 10B, a second outlet channel 126 is fluidly connected to a second nozzle arrangement 128. The shutter 120 can direct fluids in the spray head assembly 100 from the inlet channel 112 to the second outlet channel 126. Referring to FIG. 10C, a third outlet channel 130 is fluidly connected to a third nozzle arrangement 132. The shutter 120 can direct fluids in the spray head assembly 100 from the inlet channel 112 to the third outlet channel 130.

The internal components of the spray head assembly 100 described supra may be constructed of any suitable materials. These materials may include, but are not limited to, metals, alloys, thermoplastics, or other engineered materials. It may be advantageous to construct the internal components of the spray head assembly 100 from materials that are resistant to wear or chemical change associated with continuous exposure to water.

The disclosure may be embodied in other specific forms without departing from the essential attributes; therefore, the illustrated examples should be considered illustrative and not restrictive in all respects. The claims provided herein are to ensure adequacy of the present application for establishing foreign priority and for no other purpose.

Various examples of systems, devices, and methods have been described herein. These examples are given only be way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood be persons of ordinary skill in the art. Moreover, elements described with respect to one example can be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a clam.

What is claimed is:

1. A spray diverter configured to modify a spray mode of a spray head assembly, comprising:
a shutter with a plurality of openings configured to align with different sections of a channel divider fluidically coupled to one or more outlets; and
a shaft assembly coupled to a switch and the shutter configured to translate a linear movement of the switch into rotational movement of the shutter, wherein translation of the linear movement into rotational movement aligns the plurality of openings with different sections of the channel divider to modify a fluid passage to one or more different outlets.

2. The spray diverter of claim 1, wherein the different sections of the channel divider comprise at least three sections fluidically coupled to three different outlets.

3. The spray diverter of claim 2, wherein the switch is configured to move between three operating positions to selectively align the plurality of openings with the at least three sections fluidically coupled to the three different outlets.

4. The spray diverter of claim 3, wherein the switch comprises a switch body with angled portions meeting in a center of the switch body.

5. The spray diverter of claim 3, wherein the shaft assembly comprises:
a shaft housing coupled to the switch configured to shift linearly to different operating positions based on the linear movement of the switch; and
a shaft coupled to the shaft housing and the shutter with one or more fins or threads configured to translate the linear movement of the shaft housing into rotational movement of the shutter.

6. The spray diverter of claim 5, wherein the one or more fins or threads extend partially circumferentially along an exterior surface of the shaft.

7. The spray diverter of claim 6, wherein the one or more fins or threads are configured to be received by one or more grooves in the shaft housing.

8. The spray diverter of claim 7, wherein the linear shifting of the shaft housing causes rotation of the one or more fins or threads and the shutter.

9. The spray diverter of claim 5, wherein the shaft further comprises one or more openings configured to receive a pin.

10. The spray diverter of claim 5, wherein the shaft housing further comprises one or more recesses configured to couple to and leverage one or more tabs of the switch to drive linear movement of the housing.

11. A spray head assembly, comprising:
a body defining an internal cavity configured to transport a flow of liquid from an inlet to a plurality of outlets along one or more fluid paths;
a spray diverter coupled to the internal cavity of the body configured to selectively divert the flow of liquid to one of the plurality of outlets along one or more fluid paths; and
a switch coupled to the body and spray diverter configured to, based on a received user input, modify an operating position of the diverter to selectively divert the flow of liquid to one of the plurality of outlets.

12. The spray head assembly of claim 11, wherein the spray diverter is configured to divert the flow of liquid to at least one of three outlets along one or more fluid paths.

13. The spray head assembly of claim 11, wherein the spray diverter comprises:
a shutter with at least one opening configured to selectively align with different sections of a channel divider to divert the flow of liquid to one of the plurality of outlets; and
a shaft assembly coupled to the switch within the internal cavity configured to transfer linear movement of the switch into rotational movement of the shutter.

14. The spray head assembly of claim 13, wherein the shaft assembly comprises:
a shaft housing coupled to the switch configured to linearly move between a plurality of operating positions based on the received user input; and
a shaft with at least one fin or thread coupled to the shutter and shaft housing configured to transfer the linear movement of the shaft housing into the rotational movement of the shutter.

15. The spray head assembly of claim 14, wherein the switch comprises one or more tabs configured to couple to one or more recesses of the shaft housing.

16. The spray head assembly of 14, wherein the at least one fin or thread extends circumferentially along an exterior surface of the shaft and is configured to be received by one or more grooves of the shaft housing.

17. A method of diverting a flow of liquid to one of a plurality of outlets to modify a spray mode of a spray head assembly, comprising:
providing a spray head assembly having a spray diverter configured to modify a spray mode of a spray head assembly
causing a user input to be received by the spray diverter indicative of a desired spraying operation upon an actuating mechanism of the spray head assembly;
causing a shaft housing coupled to the actuating mechanism to selectively move to a different operating position on a shaft based on the received user input; and
based on the movement of the shaft housing, causing the shaft coupled to the shaft housing to rotate to align one or more openings of a shutter with one or more sections of a channel divider fluidically coupled to at least one nozzle to permit fluid passage through the at least one nozzle of the desired spraying operation.

18. The method of claim 17, wherein selectively moving the shaft housing and rotating the shaft occur simultaneously.

19. The method of claim 17, wherein the shutter further comprises a connector extending perpendicularly from the shutter configured to couple to a distal end of the shaft.

20. The method of claim 17, wherein the shaft housing is selectively moveable between at least three different operating positions on the shaft.
